(19) United States
(12) Patent Application Publication
(10) Pub. No.: US 2011/0289474 A1
(43) Pub. Date: Nov. 24, 2011

(54) MANAGING AND VIEWING DEPENDENCIES IN AN AGILE SYSTEM

(75) Inventors: Felix Sukhenko, San Francisco, CA (US); Eric Babinet, Redwood City, CA (US)

(73) Assignee: SALESFORCE.COM, INC., San Francisco, CA (US)

(21) Appl. No.: 13/083,390

(22) Filed: Apr. 8, 2011

Related U.S. Application Data
(60) Provisional application No. 61/347,279, filed on May 21, 2010.

(51) Int. Cl. G06F 9/44

(52) U.S. Cl. 717/103

(57) ABSTRACT

Example embodiments include a system and method for managing and viewing dependencies between Scrum teams working on a software release. In one embodiment, all dependency information for a release is stored in database objects on the cloud and dependencies are viewed on a user system coupled to the cloud. User interfaces for viewing, editing and creating dependencies are built on the cloud for display and interaction on the user system.

### CLAIM OF PRIORITY

This application claims the benefit of U.S. Provisional Patent Application entitled “METHODS AND SYSTEMS FOR VIEWING DEPENDENCIES IN AN AGILE SYSTEM,” filed May 21, 2010 (Application Control No. 61/134,279), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to managing and viewing dependencies between development teams in an agile software development environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which, in and of themselves, may also be inventions.

Many software developers have adopted the use of a Scrum process in an agile environment. Scrum is an iterative, incremental methodology for project management often seen in agile software development.

For example, product development may be organized into three basic business units, Applications, Platform and Core Infrastructure, and numerous Scrum teams distributed across these three business units. An example Scrum team could have dedicated developers, quality assurance engineers and a Product Owner. Each team also has a ScrumMaster, who is usually a program manager, development manager, or Quality Assurance (QA) manager. Depending on the complexity of the features being developed, the Scrum team may also have dedicated or part-time team members from other functional teams such as System Testing, Documentation, User Interface (UI) Design, Usability, Technology Operations, and Release Engineering.

In Scrum the development process is organized into a series of iterations called “sprints” which are typically two to four week periods during which a team produces a potentially shippable product increment.

The work to be done by a Scrum team is represented by the “backlog” which is a prioritized list of user “stories” or “subjects”. The individual subjects may be part of a “theme”.

Important tenets of agile software development are welcoming changing requirements, even late in development, close daily cooperation between business people and developers, face-to-face conversation between team members (co-location) and regular adaptation to changing circumstances.

### BRIEF SUMMARY

Embodiments provide mechanisms and methods for managing and viewing dependencies between teams in an agile software development environment.

While one or more implementations and techniques are described, one or more embodiments may be implemented in a system having an application server providing a front end for an on-demand database service capable of supporting multiple tenants. The embodiments described herein are not limited to multi-tenant databases or deployment on application servers. Embodiments may be practiced using other database architectures, e.g., ORACLE®, DB2® by IBM and the like, without departing from the scope of the embodiments claimed.

Any of the above embodiments may be used alone or together with one another in any combination. Embodiments described herein may also include embodiments that are only partially mentioned or alluded to, or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the embodiments described are not limited to the examples depicted in the figures.

FIG. 1 illustrates a screen shot of an example user interface that lists dependencies for a team.

FIG. 2 illustrates a block diagram of database objects that are used in an example embodiment.

FIG. 3 illustrates a flow chart depicting the operation of an example embodiment.

FIG. 4 illustrates a screen shot of an example user interface that facilitates viewing the details of a dependency.

FIG. 5 illustrates a screen shot of an example user interface that facilitates creating a new dependency.

FIG. 6 illustrates an example graphical depiction of dependencies between teams working on a software release.

FIG. 7 illustrates a screen shot of an example automatically generated notification of a dependency update.

FIG. 8 illustrates a block diagram of an example environment, which may be used to implement the embodiments described herein.

### DETAILED DESCRIPTION

### General Overview

Systems and methods are provided for managing and viewing dependencies in an agile software environment.

### System Overview

Embodiments described herein enable and facilitate dependency management in a large agile environment. As described above, with many teams working together on the same release and on shared features and code, it is impossible to anticipate all the issues, surprises, changes, failures and successes that teams will encounter during software development. That unpredictability is one reason that dependency management is difficult. Any solution must address these underlying tensions and challenges.

In an example embodiment, a user interface facilitates creation of dependencies. In this example embodiment, the user interface is displayed in a window of a browser application executing on a user system. The dependency information is maintained on a database updated by interprocess communications between the browser and database software. The database may be located on a remote server and is accessible to authorized members of a team.

In an example embodiment, a dependencies list displayed on a user workstation shows dependencies this team has on other teams and dependencies other teams have on this team. The dependencies list for this team is built from dependency information stored in one or more database objects and sent to the user system for display in a window of a browser application executing on the user system.

In an example embodiment, a graphical representation of the dependencies for this team is built from dependency information stored in the database. The graphical representation is displayed in a window of a browser application executing on the user system.

In an example embodiment email notification of dependency updates are sent to designated team members. These email notifications are triggered by changes entered into the database.

Such a dependency management system may be based on a multi-tenant cloud computing model as described in detail below.

An example embodiment will now be described in detail. A software tool facilitates dependency management in an agile software development system.

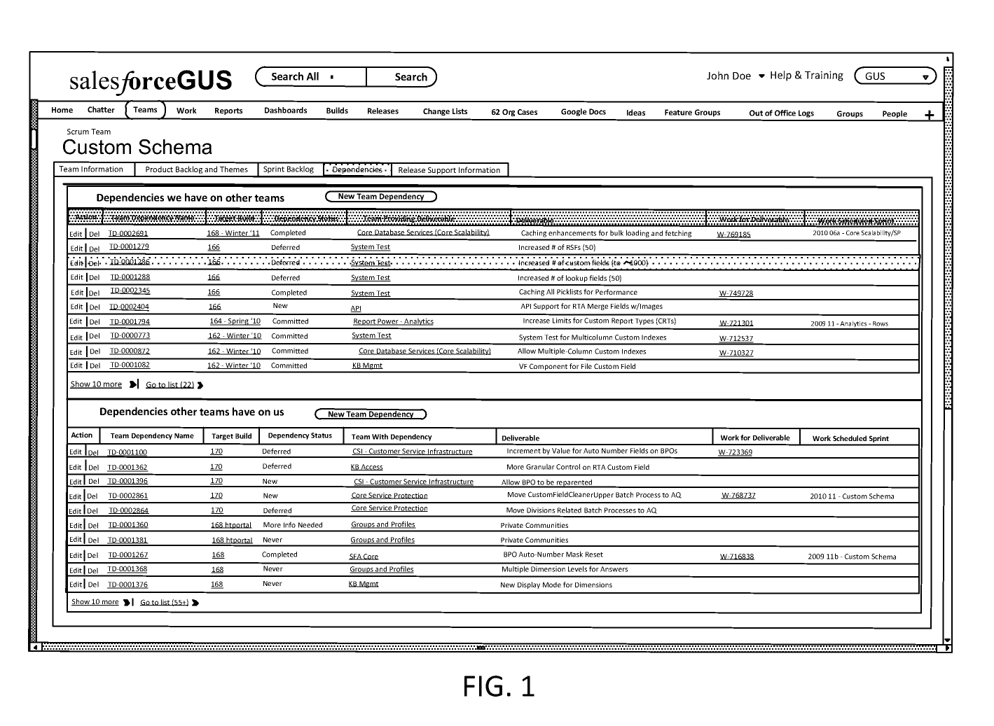

FIG. 1 is a screenshot of a dependencies list showing dependencies for a particular team. The dependencies table is divided into upper and lower panels with the upper panel showing dependencies on other teams and the lower panel showing dependencies of other teams on this particular team.

Each dependency is displayed as a row of the table and each row includes a number of fields. The fields are the same in both panels except for one field which will be described below.

The common fields are “Action” which includes the actions “Edit” or “Delete”, “Team Dependency Name”, “Target Build”, “Dependency Status”, “Deliverable”, “Work for Deliverable” and “Work Scheduled Sprint”.

The “Edit” action allows in-line changes to be made to the dependency and the “Delete” action allows the dependency to be deleted. The “Team Dependency Name” field identifies a particular dependency and provides a link to the record for the dependency. The “Target Build” field identifies the build which depends on the work being done and provides a link to the record for the target build. The “Dependency Status” field specified the status of the dependency. The “Deliverable” field is a description of the work to be delivered. The “Work for Deliverable” field is a link to the record for work to be delivered. The “Work Scheduled Sprint” field identifies a two-week period in which the work is to be completed.

In this example embodiment, the dependency status is either “New”, “Prioritized”, “Committed”, “Deferred”, “Completed”, “More Information Needed” or “Never”. A dependency has the “Committed” status when the team that has to do the work agrees to do it. If a dependency has the “Prioritized” status then the team committed to providing the dependency has assigned a priority to the work. The priority may be viewed by clicking the “Work for Deliverable” field and viewing the backlog.

The dependencies on other teams panel includes a “Team Providing Deliverable” field that identifies the team that must do the work to eliminate the dependency for this team and provides a link. The dependencies of other teams on this particular team panel includes a “Team With Dependency” field that identifies the team that is relying on this team to do the work and eliminate the dependency.

In this example embodiment information pertaining to dependencies between all the teams working on a software release is stored in a database object. Software executing on the server is utilized to build the dependencies list screen and other screens described below using information stored in database objects.

Each database can generally be viewed as a collection of objects, such as a set of logical tables, containing data fitted into predefined categories. A “table” is one representation of a data object, and may be used herein to simplify the conceptual description of objects and custom objects according to the embodiments described herein. It should be understood that “table” and “object” may be used interchangeably herein. Each table generally contains one or more data categories logically arranged as columns or fields in a viewable schema. Each row or record of a table contains an instance of data for each category defined by the fields. For agile software Scrum team database applications, such standard entities might include tables for Backlog, Builds, Deliverables and such, each containing pre-defined fields. It should be understood that the word “entity” may also be used interchangeably herein with “object” and “table.”

In some database systems, users may be allowed to create and store custom objects, or they may be allowed to customize standard entities or objects, for example by creating custom fields for standard objects, including custom index fields.

Any suitable programming language can be used to implement the routines of example embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. In the example embodiment currently described the Apex programming language and the Visualforce user interface framework are used to implement dependency management and viewing functionality.

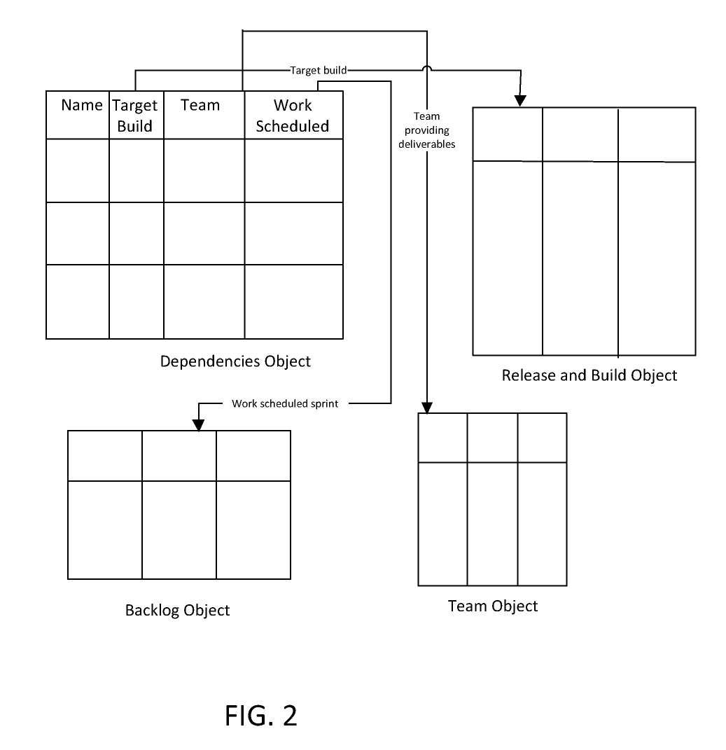

FIG. 2 is a block diagram of database objects and links used in an example embodiment. A dependency object includes records for each dependency. The dependency object includes at least the fields depicted in the dependencies list of FIG. 1. Also included in the records are links to objects maintained in the database.

For example, the “Target Build” field in a dependency object record includes a link to the record for the specified build in a “Release and Build” object. By following the link a record containing more information about the specified build can be accessed. Also, the “Work Scheduled Sprint” field in a dependency object record includes a link to the record in a “Backlog” field holding information about the priority and the sprint scheduled for completion of the specified work. The “Team Providing Deliverable” and “Team With Dependencies” fields in a dependency object record include a link to the record for the specified team in a “Team” object.

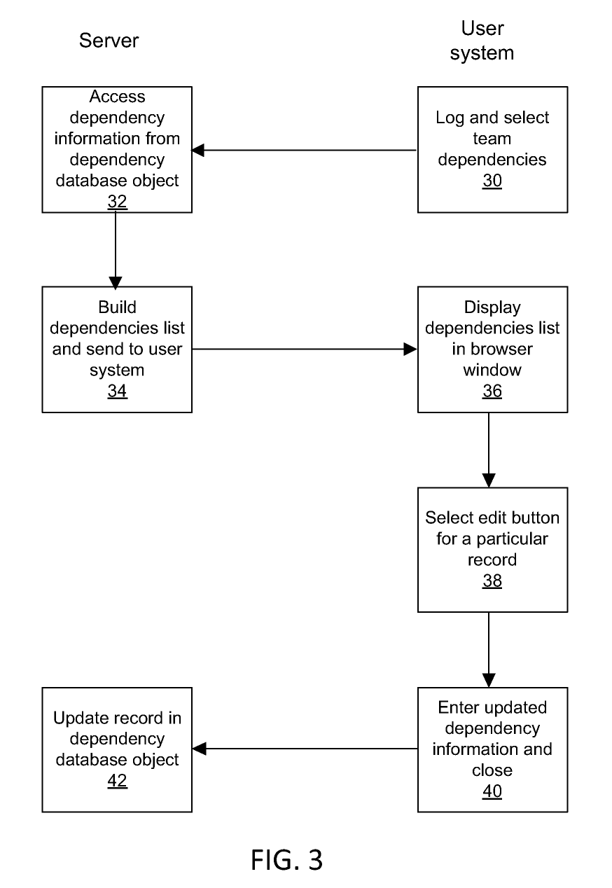

In an example embodiment a user may utilize the dependency management functionality on any user system connected to a network utilizing a cloud computing model. For example, a user system can be connected to the Internet and the databases, database management software and software for generating user interfaces can be located and implemented on server systems coupled to the Internet. FIG. 3 is a flow chart depicting the steps of accessing and updating dependency information in an example embodiment.

Turning now to FIG. 3, in process step 30 a user logs onto the system and receives a home page. Referring again to FIG. 1, a user accesses the dependencies list by first selecting the “Teams” tab in the top row of tabs in the screenshot and then the “Dependencies” tab in the Scrum Team display as indicated by the hatched tabs.

In process step 32 the server responds to a message from the browser application and accesses the dependency database object to access dependency information relating to the team.

In process step 34 software executing on the server builds the dependencies list screen shot depicted in FIG. 1 and sends the screen shot to the user system.

In process step 36 the dependencies list screen shot is displayed in the window of the browser application executing on the user system.

In process step 38 the user needs to update information for a particular dependency and selects the edit button and in process step 40 the user enters update information. When the user has completed the edit the information is forwarded to the server.

In process step 42 software executing on the server accesses the dependency database object and updates the record for the particular dependency to reflect the changes made by the user.

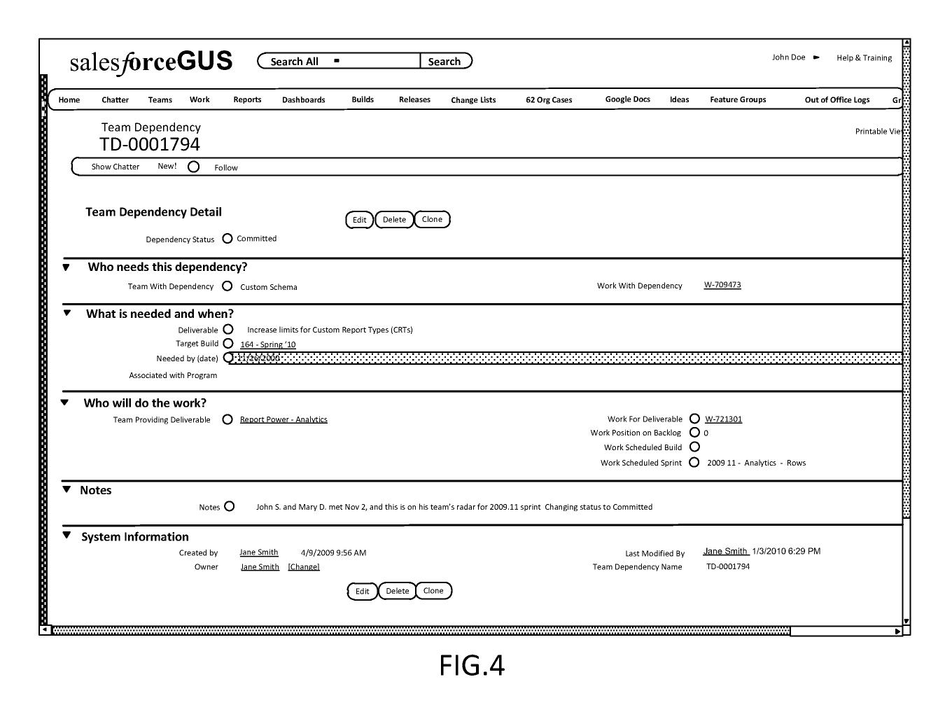

When the user selects the “Edit” action then a new User Interface is displayed. FIG. 4 depicts a screen shot of a user interface (UI) for editing a dependency record in the database. In this example, the UI is generated on a server, sent to the user system and displayed in a window of a browser application executing on the user system (“the browser window”).

In this embodiment, the UI has fields that are pre-populated with current values. The user may edit any field in a selected dependency record and the changes are made to the dependency record in the “Dependency” object when the Save button is pushed.

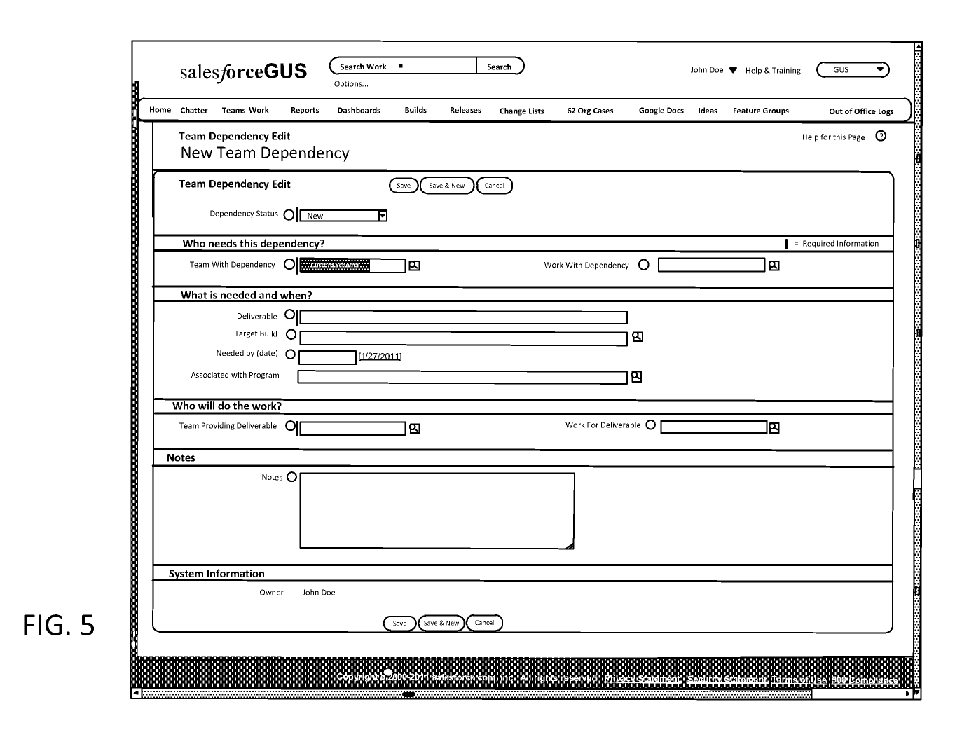

FIG. 5 depicts a screen shot of a user interface (UI) for entering a new dependency into the database. In this example, the UI is generated on a server, sent to the user system and displayed in the browser window. The user can enter values for all fields in the new dependency and can also enter “notes”.

The Uls are user friendly and facilitate entry of dependency information without requiring familiarity with database management software.

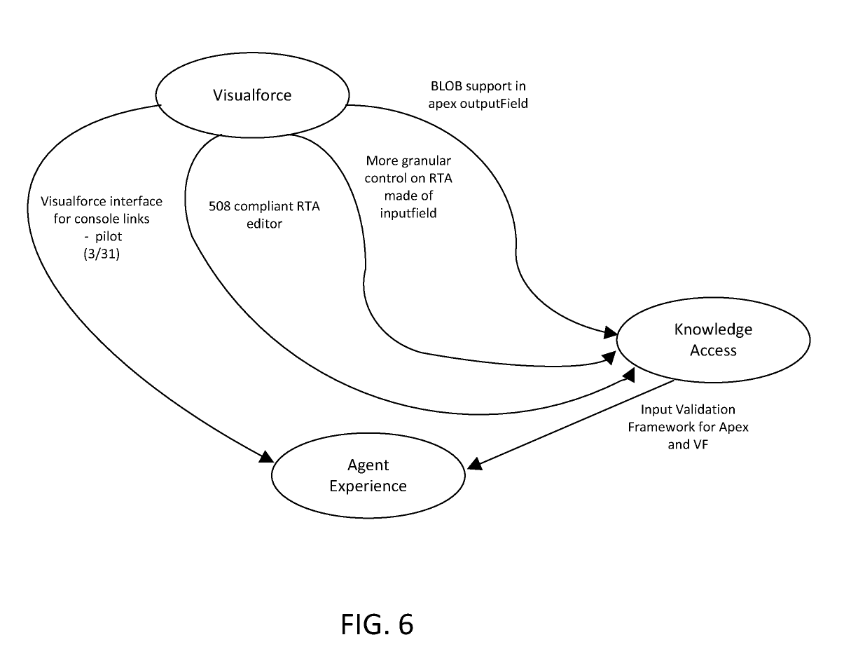

FIG. 6 is a graph depicting the dependencies between different Scrum teams working on a release. In FIG. 6 each oval is labeled with the name of a Scrum team and an arrow between two ovals represents a dependency. The arrow points from the team doing the work toward the team that is impacted by the dependency.

In an example embodiment, a public domain graphics service is utilized to generate the graph displayed on the user system. Software executing on a server translates the dependency information for a particular release stored in the “Dependency” object into a graphical language file. This graphical language file is provided over the network to the graphics service which generates a graph as depicted in FIG. 6.

An example of a graphics visualization language is available at the graphviz website with the extension .org where a Graph Visualization language is described. In an example embodiment, this language is used to create a file representing dependency information that an algorithm can graph. The file is posted to the graph website at the extension .gafol.net which provides an implementation of that algorithm as a service to others.

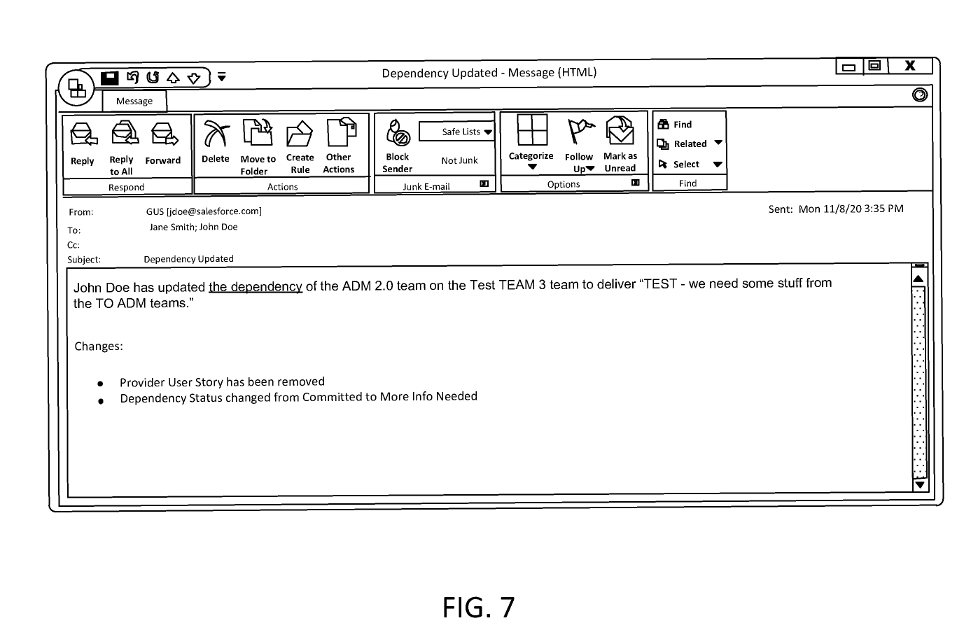

In an example embodiment, an email notification is provided to a ScrumMaster if a dependency relating to his team has been updated. FIG. 7 depicts a screen shot of an email notification listing the name of the dependency and changes made to the dependency. The notification is automatically generated by software and automatically sent to the correct recipients.

In this example embodiment, inter-process communications between a standard browser application running on a user system and a server are utilized.

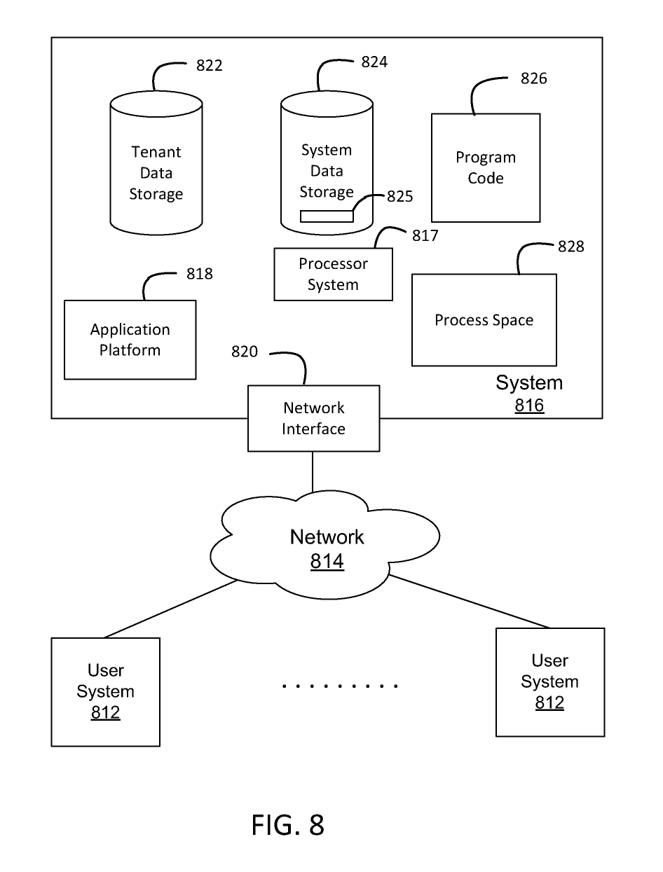

FIG. 8 illustrates a block diagram of an on-demand database system environment that facilitates the implementation of an example embodiment. The environment may include user system 812, network 814 and on-line database system 816 or “server.

Several elements in the environment shown in FIG. 8 include conventional, well-known elements that are explained only briefly here. For example, a user system 812 could include a desktop personal computer, workstation, laptop, PDA, cell phone, or any wireless access protocol (WAP) enabled device or any other computing device capable of interfacing directly or indirectly to the Internet or other network connection. User system 812 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 812 to access, process and view information, pages and applications available to it from system 816 over network 814. A user system 812 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 816 or other systems or servers. For example, the user interface device can be used to access data and applications hosted by system 816, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

User system 812 is able to communicate with server system 816 using TCP/IP, and at a higher network level uses other common Internet protocols to communicate, such as HTTP, FTP, AFS, WAP, etc. In an example where HTTP is used, user system 812 might include an HTTP client commonly referred to as a “browser” for sending and receiving HTTP messages to and from an HTTP server at on-line database system 816. Such an HTTP server might be implemented as the sole network interface between on-line database system 816 and network 814, but other techniques might be used as well or instead. In some implementations, the interface between on-line database system 816 and network 814 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

Network 814 is any network or combination of networks of devices that communicate with one another. For example, network 814 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global Internet work of networks often referred to as the “Internet” with a capital “I,” that network will be used in many of the examples herein. However, it should be understood that the networks that the one or more implementations might use are not so limited, although TCP/IP is a frequently implemented protocol.

According to one embodiment, a user system 812 and all of its components are operator configurable using applications, such as a browser, including computer code run using a central processing unit such as an Intel Pentium® processor or the like. Similarly, on-line database system 816 and all of its components might be operator configurable using application(s) including computer code to run using a central processing unit such as processor system 817, which may include an Intel Pentium® processor or the like, and/or multiple processor units.

One arrangement for elements of on-line database system 816 is shown in FIG. 8, including a network interface 820, processor system 817, application platform 818, tenant data storage 822 for tenant data, system data storage 824 for system data 825 accessible to system 816 and possibly multiple tenants, program code 826 for implementing various functions of system 816, and a process space 828 for executing system processes.

According to one embodiment, each server system 816 is configured to provide web pages, forms, applications, data and media content to user (client) systems 812 to support the access by user systems 812 as tenants of system 816. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

A computer program product embodiment includes a machine-readable storage medium (media) having instructions stored thereon/in which can be used to program a computer to perform any of the processes of the embodiments described herein. Computer code for operating and configuring system 816 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, as is well known in the art, the entire program code, or portions thereof, may be transmitted and downloaded from a software source over a transmission medium, e.g., over the Internet, or from another server or transmitted over any other conventional network connection (e.g., extranet, VPN, LAN, etc.) using any communication medium and protocols (e.g., TCP/IP, HTTP, HTTPS, Ethernet, etc). It is also well known that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages. (Java™ is a trademark of Sun Microsystems, Inc.).

In an example embodiment the dependency management user interfaces are generated by the server 816 executing Force.com platform software on the application platform 818 and displayed in a window of a standard browser application operating on the user system 812. Interprocess communication between the server 816 and user system takes place over the network 814 using, for example, TCP/IP.

It will also be appreciated that one or more of the elements depicted in the drawings/figures can also be implemented in a more separated or integrated manner, or even removed or rendered as inoperable in certain cases, as is useful in accordance with a particular application.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for managing and viewing dependencies between teams working on a software release, the method comprising:
receiving, at a server, a dependency information request from a browser application executing on a user system, with the user system and the server coupled to a network and with the request including the identity of a specific team working on the software release;
accessing, using a processor, a dependency database object to obtain dependency information pertaining to the specific team;
building, using the processor, a list of dependencies for the specified team using the dependency information obtained from the dependency database object, with the list having a row for each dependency and with fields in the list including the name of the dependency, the status of the dependency, the team doing the work or the team dependent on the work being done and an identification of a deliverable that creates the dependency; and
sending the list of dependencies to the user system, with the list of dependencies configured to be displayed in a window of a browser application executing on the user system.

2. The method of claim 1 further comprising:
including an action field in the list of the dependencies, with the action field including an edit button configured to cause an edit user interface to be displayed in the window of the browser application executing on the user system when the edit button is activated;
receiving, from the browser application, update information relating to a particular dependency entered in the edit user interface; and
updating, using the processor, a record in the dependency database object of the particular dependency with the update information.

3. The method of claim 1 further comprising:
automatically sending a notification, using the processor, when an update to a dependency record occurs.

4. The method of claim 1 further comprising:
encoding, using the processor, dependency information into a graphics language file;
providing the graphics language file to a graphics service to create a graph depicting the dependency information; and
sending the graph to the user system for display in a window of a browser application executing on the user system.

5. A system for managing and viewing dependencies between teams working on a software release, the system comprising:
means for receiving a dependency information request from a browser application executing on a user system, with the user system coupled to a network and with the request including the identity of a specific team working on the software release;
means for accessing a dependency database object to obtain dependency information pertaining to the specific team;
means for building a list of dependencies for the specified team using the dependency information obtained from the dependency database object, with the list having a row for each dependency and with fields in the list including the name of the dependency, the status of the dependency, the team doing the work or the team dependent on the work being done and an identification of a deliverable that creates the dependency; and
means for sending the list of dependencies to the user system, with the list of dependencies configured to be displayed in a window of a browser application executing on the user system.

6. The system of claim 5 further comprising:
means for including an action field in the list of the dependencies, with the action field including an edit button configured to cause an edit user interface to be displayed in the window of the browser application executing on the user system when the edit button is activated;
means for receiving, from the browser application, update information relating to a particular dependency entered in the edit user interface from the browser application; and
means for updating a record in the dependency database object of the particular dependency with the update information.

7. The system of claim 5 further comprising:
means for automatically sending a notification when an update to a dependency record occurs.

8. The system of claim 5 further comprising:
means for encoding dependency information into a graphics language file;
means for providing the graphics language file to a graphics service to create a graph depicting the dependency information; and
means for sending the graph to the user system for display in a window of a browser application executing on the user system.

9. An apparatus for managing and viewing dependencies between teams working on a software release, the apparatus comprising:
a processor; and
a storage device storing one or more stored sequences of instructions which when executed by the processor cause the processor to:
receive a dependency information request from a browser application executing on a user system, with the user system coupled to a network and with the request including the identity of a specific team working on the software release;
access a dependency database object to obtain dependency information pertaining to the specific team;
build a list of dependencies for the specified team using the dependency information obtained from the dependency database object, with the list having a row for each dependency and with fields in the list including the name of the dependency, the status of the dependency, the team doing the work or the team dependent on the work being done and an identification of a deliverable that creates the dependency; and
send the list of dependencies to the user system, with the list of dependencies configured to be displayed in a window of a browser application executing on the user system.

10. The apparatus of claim 9 wherein the instructions further cause the processor to:
include an action field in the list of the dependencies, with the action field including an edit button configured to cause an edit user interface to be displayed in the window of the browser application executing on the user system when the edit button is activated;
receive, from the browser application, update information relating to a particular dependency entered in the edit user interface; and
update a record in the dependency database object of the particular dependency with the update information.

11. The apparatus of claim 9 wherein the instructions further cause the processor to:
automatically send a notification when an update to a dependency record occurs.

12. The apparatus of claim 9 wherein the instructions further cause the processor to:
encode dependency information into a graphics language file;
provide the graphics language file to a graphics service to create a graph depicting the dependency information; and
send the graph to the user system for display in a window of a browser application executing on the user system.
